(19) United States
(12) Patent Application Publication
(10) Pub. No.: US 2006/0048222 A1
(43) Pub. Date: Mar. 2, 2006

(54) Secure electronic delivery seal for information handling system

(76) Inventors: Clint H. O'Connor, Austin, TX (US); Douglas M. Anson, Dripping Springs, TX (US)

Correspondence Address: HAMILTON & TERRILE, LLP, P.O. BOX 203518, AUSTIN, TX, 78720, US

(21) Appl. No.: 10/929,067

(22) Filed: Aug. 27, 2004

(51) Int. Cl. G06F 12/14

(52) U.S. Cl. 726/22

(57) ABSTRACT

A method and apparatus for ensuring the security of a particular configuration of hardware and software for an information handling system that is assembled using a “build-to-order” system. The present invention ensures the security and integrity of data on an information handling system from the point of manufacture to the final destination at the customer's facility. The information handling system is then manufactured with the operating system and a predetermined set of software being installed thereon. A manifest file is constructed comprising a predetermined set of data files and configuration information. The manifest file is electronically signed with at least one electronic key. When the information handling system performs its initial boot, a second electronic key is used to extract information from the manifest file and the existing data files and configuration information is compared to the information contained in the manifest file. If any of the information compared to the manifest has been altered, the initial boot is designated as “invalid” and the user is notified of the potential for a breach of security.

### BACKGROUND OF THE INVENTION

1. Field of the Invention

The present invention relates in general to the field of information handling systems and, more particularly, to a method and apparatus for ensuring the security and integrity of software and data on an information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In recent years, there has been an increase in the number of information handling systems that are manufactured based on a “build to order” process that allows a customer to specify hardware and software options. Currently, a “build to order” manufacturer often ships information handling systems from the factory to the customer. In the case of smaller customers, the customer may receive the system directly. For larger customers, however, the information handling system may pass through a number of intermediate entities such as value added resellers (VARs).

In general, there is no assurance for the customer that the contents of the information handling system have not been modified after leaving the secure set-up area at the manufacturing facility. Ensuring the security and integrity of the system contents is essential, however, since the system contents may include confidential customer set-up information including provisioning data, configuration data, and other sensitive information.

Efforts are underway in the industry to promote secure computing systems. However, there is no current system or procedure for ensuring the security of information handling systems from a manufacturing facility to the customer. In view of the foregoing, there is a need for a method and apparatus to ensure the security and integrity of software and data contained on a “build to order” information handling system.

### SUMMARY OF THE INVENTION

The present invention overcomes the shortcomings of the prior art by providing a method and apparatus for ensuring the security of a particular configuration of hardware and software for an information handling system that is assembled using a “build-to-order” system. Specifically, the present invention ensures the security and integrity of data on an information handling system from the point of manufacture to the final destination at the customer's facility.

The method and apparatus of the present invention is implemented using a plurality of electronic keys to generate electronic seals and to verify the contents of a predetermined set of data and system parameters contained in a manifest file that is stored in the information handling system. In one embodiment of the invention, the electronic seal is generated using public key infrastructure (PKI) encryption keys. In an alternate embodiment of the invention, the electronic seal is generated using symmetric keys.

In the embodiment of the invention that is implemented using a PKI key, a customer provides a public key at the time an order is placed for an information handling system. The information handling system is then manufactured with the operating system and a predetermined set of software files is installed thereon. When the process of fabricating the information handling system is complete, a manifest file is constructed comprising a plurality of specified files, registry settings, provisioning information, and any additional information needed for a specific level of security. The manufacturer then “signs” this manifest with a private key and the customer's public key. When the information handling system performs its initial boot, the public key provided by the manufacturer is extracted from the storage in the information handling system and a comparison is made of the BIOS and the CMOS against the information contained in the encrypted manifest. If any of the information compared to the manifest has been altered, the initial boot is designated as “invalid” and the user is notified of the potential for a breach of security.

If the system passes the test conducted during the initial boot sequence, the system then requests the customer to provide private key information. The customer-provided private key is used to verify (or to re-verify and/or decrypt where necessary) all of the “signed” information and the customer configuration/ordering information.

In an alternate embodiment of the invention, the electronic seal is generated using a symmetric key. In this embodiment, the information handling system is manufactured with the operating system and a predetermined set of software is installed thereon. When the process of fabricating the information handling system is complete, a manifest file is constructed comprising a plurality of specified files, registry settings, provisioning information, and any additional information needed for a specific level of security. The manufacturer then “signs” this manifest with the manufacturer's private key and the symmetric key which has been provided to the customer at the time of purchase. When the information handling system performs its initial boot, the public key provided by the manufacturer is extracted from the storage in the information handling system and a comparison is made of the BIOS and the CMOS against the information contained in the encrypted manifest. If any of the information compared to the manifest has been altered, the initial boot is designated as “invalid” and the user is notified of the potential for a breach of security.

If the system passes the test conducted during the initial boot sequence, the system then requests the customer to provide a symmetric key. The customer-provided symmetric key is used to verify (or to re-verify and/or decrypt where necessary) all of the “signed” information and the customer configuration/ordering information.

The alternate embodiment comprising a symmetric key has the advantage of minimizing vulnerability and maximizing flexibility. For example, the symmetric key embodiment can be used for a dealer or a vendor who can print out the key for a customer. As discussed herein, the symmetric key in combination with information stored in the computer provides a comprehensively secure system since the end user must have physical possession of the computer in order to initiate the initial boot sequence using the symmetric key.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of an automated build-to-order system for installing software on an information handling system.

FIG. 2 is a system block diagram of an information handling system.

FIG. 3 is an illustration of the key components of a secure data delivery system for an information handling system.

FIG. 4 is an illustration of alternate delivery pathways for information handling systems implementing the data security system of the present invention.

FIG. 5 is a flowchart illustration of the steps implemented in the method and apparatus of the present invention.

### DETAILED DESCRIPTION

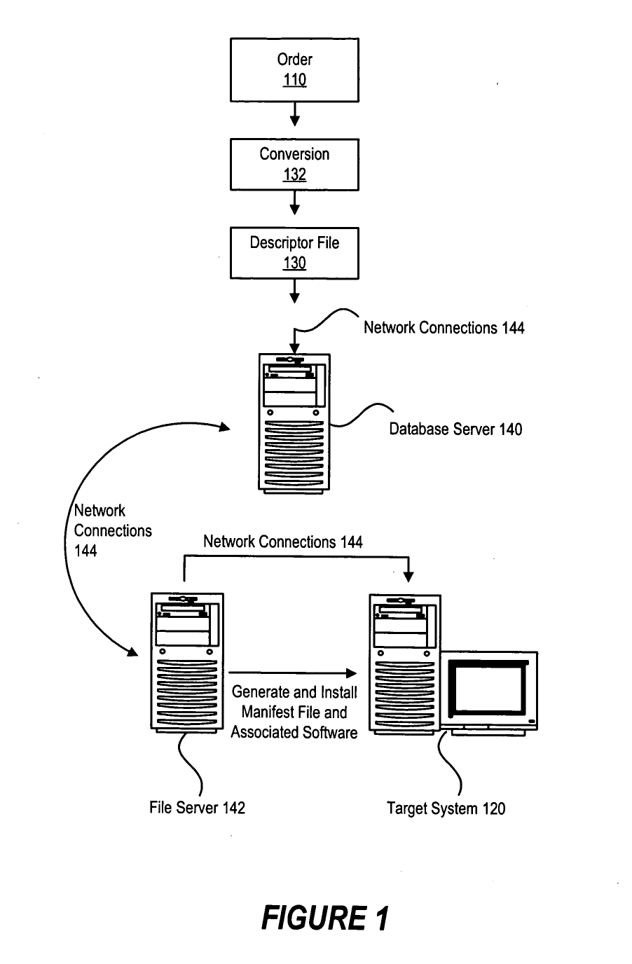

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor and software. The software may include a particular version of an operating system along with all appropriate driver software and other application software along with appropriate software bug fixes. Before target information handling system 120 is shipped to the customer, the plurality of components are installed and tested. Such software installation and testing advantageously ensures a reliable, working information handling system which is ready to operate when received by a customer.

Because different families of information handling systems and different individual computer components require different software installation, it is necessary to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In an embodiment of the present invention, the component descriptors are included in a descriptor file called a system descriptor record which is a computer readable file containing a listing of the components, both hardware and software, to be installed onto target information handling system 120. Having read the plurality of component descriptors, database server 140 provides a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 120. The software installation is controlled by a software installation management server that is operable to control the installation of the operating system and other software packages specified by a customer.

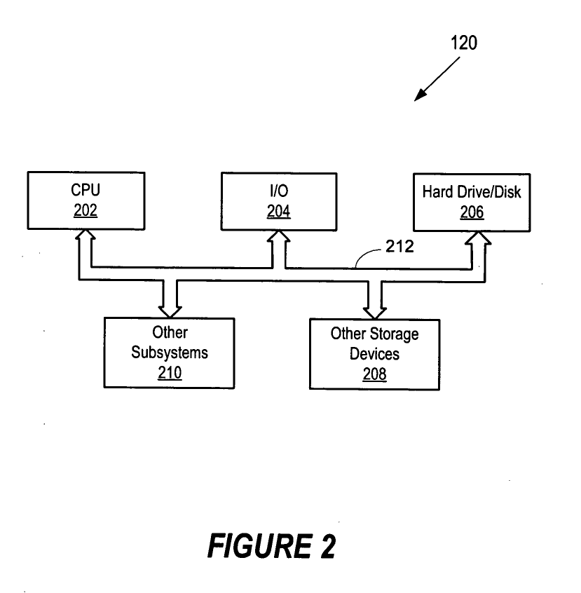

FIG. 2 is a generalized illustration of an information handling system, such as the target information handling system 120 illustrated in FIG. 1. The information handling system includes a processor 202, input/output (I/O) devices 204, such as a display, a keyboard, a mouse, and associated controllers, a hard disk drive 206, and other storage devices 208, such as a floppy disk and drive and other memory devices, and various other subsystems 210, all interconnected via one or more buses 212. The software that is installed according to the versioning methodology is installed onto hard disk drive 206. Alternately, the software may be installed onto any appropriate non-volatile memory. The non-volatile memory may also store the information relating to which factory build environment was used to install the software. Accessing this information enables a user to have additional systems corresponding to a particular factory build environment to be built.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices, as well as various input and output (I/O) devices, such as a keyboard, a mouse, and a video display. The information handling system may also include one or more buses operable to transmit communications between the various hardware components.

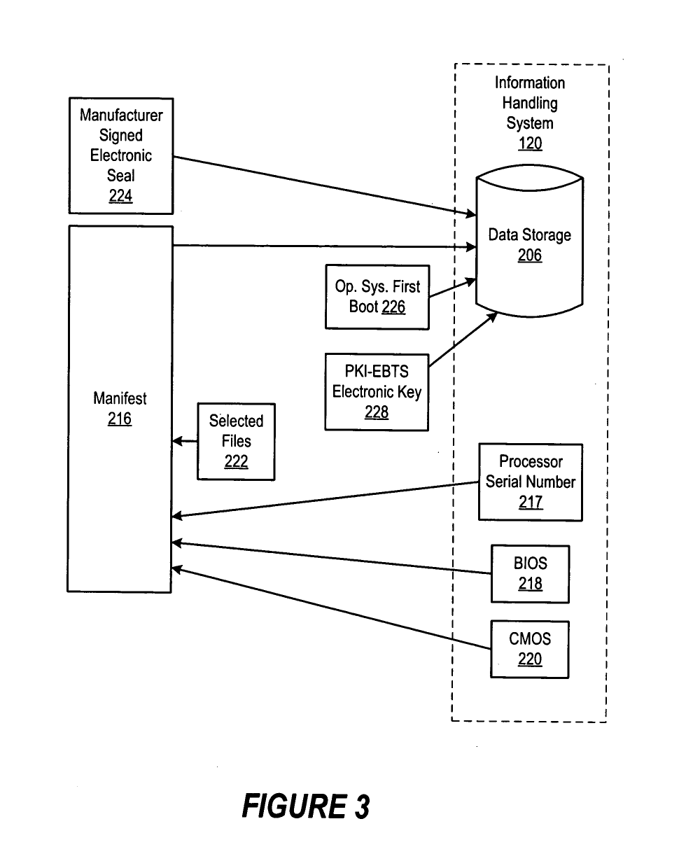

FIG. 3 is an illustration of the key components of a secure data delivery system for an information handling system. The hard drive 206 comprises a partition wherein information relating to the configuration of the information handling system is stored. A manifest file 216 comprises a plurality of files relating to the information handling system. For example, the manifest file 216 can include information relating to a processor serial number 217, information relating to the system BIOS 218 and other configuration information stored in CMOS 220. In addition, a predetermined selection of files 222, including configuration registers and other customer defined data is stored on the manifest 216. A “signed” file, sometimes referred to herein as an electronic “seal,” 224 is also stored on the hard drive 206. The electronic seal provides an authentication of the contents of the manifest and any tampering with the contents of the manifest will result in the electronic seal being “broken.” In addition, a kernel for the operating system used in the first boot 226 is stored on the hard drive 206 and information relating to the electronic key 228 may be stored on the hard drive. In some embodiments of the invention, the electronic key 228 will comprise the public key of a manufacturer in accordance with PKI protocols.

In one embodiment of the present invention, the security is based on a PKI system. In an alternate embodiment however, a customer can order a system from the manufacturer over a secure SSL-protected link. If the customer does not have a PKI key, the customer can request a symmetric key instead, which is displayed on a web page and can be saved or printed by the customer. Using a secure socket layer (SSL) security system, information relating to the symmetric key is maintained in a secure environment.

When the information handling system 120 arrives at the customer's site, the customer uses the symmetric key to “break the seal.” The symmetric key embodiment is particularly useful for consumers who may not have a public key or do not know how to use one. For example, if the computer is a gift, the customer can print out the key and give it to the recipient of the gift. Even if the key is exposed through unsecured e-mail, it is necessary to have physical possession of the computer to use it. This embodiment also avoids the positive verification requirement of obtaining a copy of the manufacturer's public key directly from the Internet rather than relying on the key stored on the hard drive. The alternate embodiment comprising a symmetric key also has the advantage of minimizing vulnerability and maximizing flexibility. For example, the symmetric key embodiment can be used for a dealer or a vendor who can print out the key for a customer. As discussed hereinabove, the symmetric key in combination with information stored in the computer provides a comprehensively secure system since the end user must have physical possession of the computer in order to initiate the initial boot sequence using the symmetric key.

The contents of the manifest file 216 and the level of security verification can vary depending on predetermined security parameters selected by the manufacturer or the customer for a desired level of security. For example, at one level of security, the security information can comprise signed configuration files and a manifest file containing a predetermined set of operating system and boot files. At this level of security, the initial boot security can include a checksum verification of the BIOS and the CMOS, and the verification can be conducted with or without the public key of the end user. In another level of security, the security information can include a signed checksum of the entire hard drive 206 and a checksum verification of the entire hard drive and the BIOS and CMOS during the initial boot. This level of security can also be implemented with or without the public key of the end user. A third level of security can include encrypted customer configuration files, signed operating system and boot files, and various checksum verifications performed using electronic keys in accordance with PKI protocols. A fourth level of security can include encrypted customer configuration files, a signed checksum of the entire hard drive 206, and a checksum verification of the BIOS and CMOS using electronic keys in accordance with PKI protocols.

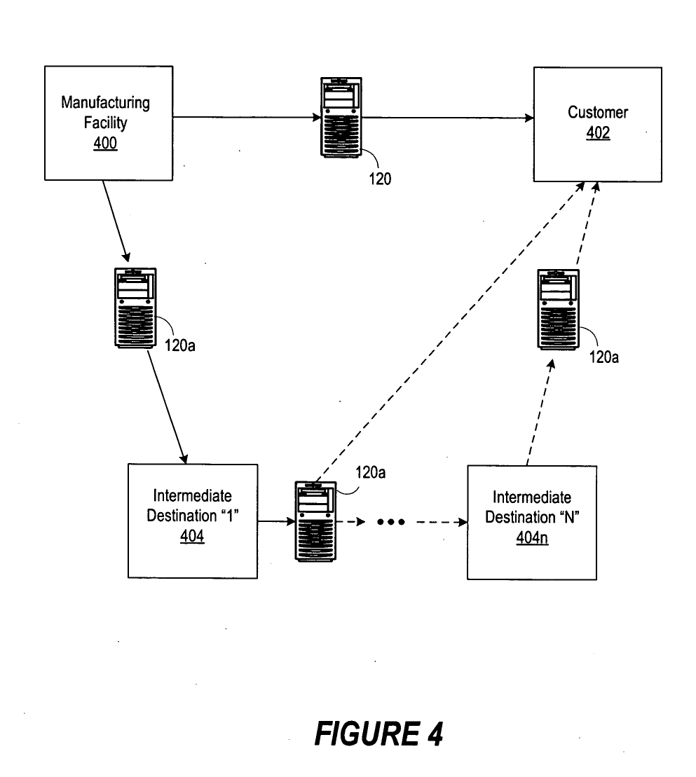

FIG. 4 is an illustration of alternate delivery pathways for information handling systems implementing the data security system of the present invention. In one embodiment of the invention, an information handling system can be delivered directly from a manufacturing facility 400 to a customer 402. The information handling system 120 includes a manifest file 216 and the manufacturer's electronic seal 224. In an alternate embodiment of the invention, the information handling system 120 is delivered to an intermediate destination 404, which can be a consultant or a value reseller (VAR) that modifies the information handling system 120 by installing a specialized set of software and/or hardware enhancements. After the enhancements have been added to the information handling system, the VAR will install a modified manifest file 216 and modified electronic seal 224 on the information handling system 120a as described hereinabove. The information handling system 120a can then be delivered to the customer 402 or can be delivered to another intermediate destination 403n for additional hardware and software modifications. After the enhancements have been added to the information handling system, each of the intermediate VARs will install a modified manifest file 216 and modified electronic seal 224 on the information handling system 120a in accordance with the present invention. Once the information handling system 120a arrives at the customer 402, an initial boot sequence is initiated and the integrity of the data on the information is verified as described hereinabove. The final version of the modified electronic seal 224 contains information that can be used to establish a “chain of title” to document the modifications made to the information handling system 120a by each of the intermediate VARs. Moreover, the present invention can be used to “roll back” signatures to identify individual digital signatures for each entity that modified the information handling system 120a in its path from the manufacturer 400 to the final user 402.

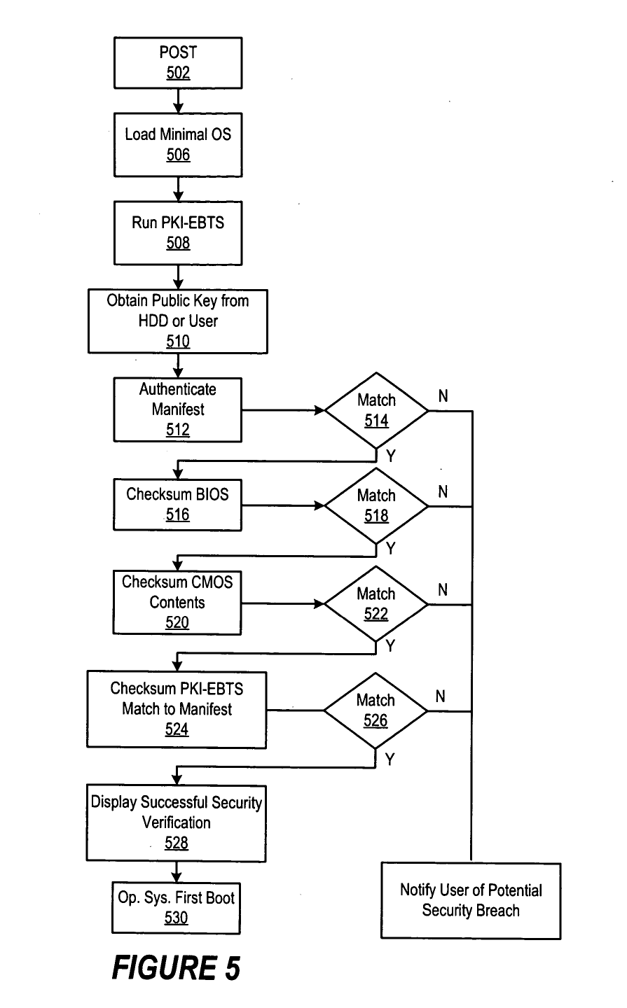

FIG. 5 is a flowchart illustration of the steps implemented in the method and apparatus of the present invention. In step 502, the system is posted and a minimal operating system is loaded in step 506. In step 508, the data security verification program is implemented. In step 510, the manufacturer provided public key is obtained from the hard drive and an algorithm is run in step 512 to authenticate the contents of the manifest file. In step 514, a test is run to determine whether the various system components match the data contained in the authentication manifest. If the test conducted in step 514 indicates that the system contents do not match the manifest, a notice is provided to the user. If, however, the test run in step 514 indicates that the system components do match the manifest file, processing continues to step 516 wherein a checksum algorithm is run to verify the contents of the BIOS. In step 518, a test is conducted to determine whether the results of the checksum operation for the BIOS match the contents of the manifest file. If the test conducted in step 518 indicates that the BIOS does not match the contents of the manifest file, a notice is provided to the user. If, however, the test conducted in step 518 indicates that the BIOS does match the contents of the manifest file, processing continues to step 520 wherein a checksum algorithm is executed to determine whether the contents of the CMOS memory match the contents of the manifest file. In step 522, a test is conducted to determine whether the checksum algorithm executed in step 520 indicates that the contents of the CMOS memory match the manifest file. If the test conducted in step 522 indicates that the contents of the CMOS memory do not match the manifest file, the user is notified. If, however, the results of the test conducted in step 522 indicate that the contents of the CMOS memory do match the manifest file, processing continues to step 524 wherein a checksum algorithm is executed to use the PKI-EBTS data to confirm whether the electronic key matches the manifest file. In step 526, a test is conducted to determine whether the checksum algorithm executed in step 524 indicates that that PKI-EBTS data matches the manifest. If the test conducted in step 526 indicates that the contents of the PKI-EBTS data do not match the manifest, the user is notified. If, however, the results of the test conducted in step 526 indicate that the PKI-EBTS data does match the manifest, processing continues to step 528 wherein the manufacturer “Electronic Break The Seal” algorithm is executed and the user is requested to provide appropriate input to initiate operation of the data handling system. In step 530, the initial boot of the operating system is conducted and the software for the system is installed on the information handling system. While maximum security is obtained by implementing all of the steps discussed hereinabove, it will be understood by those of skill in the art that a subset of these security and verification steps can be implemented to provide effective security for a particular configuration of hardware and software for an information handling system within the scope of the present invention.

### Other Embodiments

Other embodiments are within the following claims.

Although the present invention has been described in detail, it should be understood that various changes, substitutions and alterations can be made hereto without departing from the spirit and scope of the invention as defined by the appended claims.

What is claimed is:

1. A security system for an information handling system, comprising:
a data storage device operable to store a plurality of data files;
a manifest file stored on said data storage device, wherein said manifest file comprises a predetermined set of data files selected from said plurality of data files and wherein said predetermined set of data files has a known status;
an electronic seal stored on said data storage device, wherein said electronic seal is generated using at least one electronic key;
wherein, upon initialization of said information handling system, said electronic seal is electronically verified and is used to initiate a comparison operation wherein the predetermined set of data files in said manifest is compared to the corresponding set of data files stored on said data storage device to determine the security status of said information handling system.

2. The system of claim 1, wherein said electronic key is automatically extracted from said storage device upon initialization of said information handling system.

3. The system of claim 1, wherein said electronic seal is generated using a first plurality of electronic keys implemented using a public key infrastructure.

4. The system of claim 3, wherein said first plurality of security keys used to generate said electronic seal comprises at least one public key for a first party and at least one private key for a second party.

5. The system of claim 4, wherein said electronic seal is verified using a second plurality of security keys comprising at least one private key for said first party and at least one public key for said second party.

6. The system of claim 1, further comprising a modified manifest file corresponding to a predetermined set of data files having a known modified status and further comprising a modified electronic seal corresponding to said modified manifest wherein said modified electronic seal is generated using at least one electronic key.

7. The system of claim 6, wherein said modified electronic seal is generated using a first plurality of electronic keys implemented using a public key infrastructure.

8. The system of claim 7, wherein said first plurality of security keys used to generate said electronic seal comprises at least one public key for a first party and at least one private key for a second party.

9. The system of claim 8, wherein said modified electronic seal is verified using a second plurality of security keys comprising at least one private key for said first party and at least one public key for said second party.

10. The system of claim 6, wherein said modified manifest file contains data files having a known modified status corresponding to a series of successive modifications thereof and wherein said modified electronic seal comprises data corresponding to a series of electronic seals generated in association with said successive modifications of said manifest file.

11. A method for verifying security of data delivered on an information handling system, comprising:
storing a manifest file stored on a data storage device in said information handling system, wherein said manifest file comprises a predetermined set of data files selected from said plurality of data files, and wherein said predetermined set of data files has a known status;
generating an electronic seal using at least one electronic key;
storing said electronic seal on said data storage device;
verifying said electronic seal, upon initialization of said information handling system; and
using said electronic seal to initiate a comparison operation wherein the predetermined set of data files in said manifest is compared to the corresponding set of data files stored on said data storage device to determine the security status of said information handling system.

12. The method of claim 11, wherein said electronic key is automatically extracted from said data storage device upon initialization of said information handling system.

13. The method of claim 11, wherein said electronic seal is generated using a first plurality of electronic keys implemented using a public key infrastructure.

14. The method of claim 13, wherein said first plurality of security keys used to generate said electronic seal comprises at least one public key for a first party and at least one private key for a second party.

15. The method of claim 14, wherein said electronic seal is verified using a second plurality of security keys comprising at least one private key for said first party and at least one public key for said second party.

16. The method of claim 11, further comprising a modified manifest file corresponding to a predetermined set of data files having a known modified status and further comprising a modified electronic seal corresponding to said modified manifest wherein said modified electronic seal is generated using at least one electronic key.

17. The method of claim 16, wherein said modified electronic seal is generated using a first plurality of electronic keys implemented using a public key infrastructure.

18. The method of claim 17, wherein said first plurality of security keys used to generate said electronic seal comprises at least one public key for a first party and at least one private key for a second party.

19. The method of claim 18, wherein said modified electronic seal is verified using a second plurality of security keys comprising at least one private key for said first party and at least one public key for said second party.

20. The method of claim 16, wherein said modified manifest file contains data files having a known modified status corresponding to a series of successive modifications thereof and wherein said modified electronic seal comprises data corresponding to a series of electronic seals generated in association with said successive modifications of said manifest file.
